(19) United States
(12) Patent Application Publication
(10) Pub. No.: US 2006/0151993 A1
(43) Pub. Date: Jul. 13, 2006

(54) Tamper evident security document

(76) Inventor: Joshua Robert Nemeth, Victoria (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/535,032

(22) PCT Filed: Nov. 14, 2003
(86) PCT No.: PCT/AU03/01505

§ 371 Date: Oct. 21, 2005

(30) Foreign Application Priority Data
Nov. 14, 2002 (AU) 2002952669

(51) Int. Cl. B42D 15/00

(52) U.S. Cl. 283/107; 283/109

(57) ABSTRACT

A laminated tamper evident security document (10) is provided which has a transparent or translucent support layer (12), first and second security layers (16, 16′) on opposite sides of the support layer (12), first and second tamper evident layers (14, 14′) between the support layer (12) and the security layers (16, 16′) layers of printed information (22) over the security layers (16, 16′) and polymeric outer layers (18). The security layers (16, 16′) have security regions (26, 26′) which together form a composite security device or image (30) to indicate an authentic security state. Upon exposure to predetermined conditions to delaminate the document at least one of the tamper evident layers (14, 14′) is arranged to destruct or otherwise affect at least one of the security layers (16, 16′) to indicate an unauthentic state. In one embodiment each of the tamper evident layers (14, 14′) are formed from a weakly coherent or adherent material having a glass transition temperature lower than that of the other layers so that the tamper evident layer (14) separates a portion of the document containing one of the security layers (16) from the remainder of the security document (10) containing the other security document.

The present invention relates to security documents or tokens.

The term “security documents” used throughout the specification includes identify, value or entrance documents and tokens, which in turn respectively include: passports, visas, identity cards, drivers licences and security entrance cards; bank notes, shares, bonds, certificates, cheques, lottery tickets, bank cards, charge cards and credit cards; and aeroplane tickets, bus tickets, rail road tickets and tickets to fun parks or specific rides. These security documents or tokens typically include some form of authenticity verification to guard against copying and fraudulent alternation. The authenticity verification often includes a magnetic strip, but may include other forms of verification such as a signature and/or photographic image.

In view of requirements for increasing levels of security, it is desirable to provide an alternative security document or token. It is also desirable to provide a security document or token which includes means for preventing or indicating fraudulent alteration.

In a first aspect of the present invention there is provided a security document comprising:

a transparent or translucent support layer;

a first security layer provided on one side of the support layer;

a second security layer provided on the opposite side of the support layer;

the first and second security layer provided on the opposite side of the support layer;

the first and second layers having security regions which together form a composite security image or device to indicate an authentic security state;

a first tamper evident means provided between the support layer and the first security layer;

a second tamper evident means provided between the support layer and the second security layer;

wherein upon exposure of the security document to predetermined conditions to delaminate the document, at least one of the tamper evident means is arranged to destruct or otherwise affect at least one of the security layers to indicate an unauthentic security state.

According to a second aspect of the invention, there is provided a method of manufacturing a laminated security document comprising:

applying a first tamper evident means on one side of a transparent or translucent support layer;

applying a second tamper evident means on the opposite side of the transparent or translucent support layer;

applying a first security layer over the first tamper evident means;

applying a second security layer over the second tamper evident means;

the first and second security layers having security regions which together form a composite security device or image to indicate an authentic security state; and

wherein, upon exposure of the security document to predetermined conditions to delaminate the document, at least one of the tamper evident means is arranged to destruct or otherwise affect at least one of the security layers to indicate an unauthentic security state.

The security document may comprise, for example, any one of the following: identity documents such as passports, visas, identity cards, drivers licenses, and security entrance cards; value documents such as bank notes, shares, bonds, certificates, cheques, lottery tickets, bank cards, charge cards and credit cards; and entrance documents such as aeroplane tickets, bus tickets, railroad tickets and tickets to fun parks or specific rides.

In a preferred embodiment, at least one of the tamper evident means may be arranged, upon exposure of the security document or token to the predetermined conditions, to separate a portion of the security document or token from the remainder of the security document or token and prevent indication, by removing part of the composite security image or device, of the authentic security state. Preferably, the tamper evident means comprises a region which destructs or deforms upon exposure to the predetermined conditions to result in separation of said portion of said security document or token.

Alternatively or additionally, tamper evident means may be arranged to change appearance upon exposure to the predetermined conditions. For example, the tamper evident means may include a material which changes from a transparent or translucent state to a coloured or opaque state or which changes colour.

Preferably, said composite security device is arranged to indicate said authentic security state visually. The authentic security state is preferably determined by simultaneous viewing said two or more security regions.

At least one of the tamper evident means may comprise a tamper-evident separation region of the security document or token which is arranged to join said portion of said security document or token with said remainder of said security document or token when security document or token is not exposed to said one or more predetermined conditions. The tamper evident separation region is preferably predisposed to at least partially deform or destruct upon exposure to said one or more predetermined conditions. The separation region preferably comprises a tamper evident layer of said security document.

In a preferred form of the invention, at least one of the tamper evident means comprises a layer of a laminated security document or token. The tamper evident layer may be a weakly coherent or adherent layer, e.g. formed of a material having a glass transition temperature which is lower than that of one or more other laminated layers of the security document or token. Preferably, the tamper evident layer has a glass transition temperature which is lower than that of the material from which the support layer is formed.

Preferably, at least one polymeric outer layer is applied over at least one of the security layers. The outer layer preferably has a glass transition temperature which is higher than that of the tamper evident layer.

At least one of the tamper evident means may comprise an adhesive arranged to at least partly adhere two or more layers of a laminated security document. Alternatively, the document separation region may comprises a weakly coherent region of said security document resulting from coherence of laminated layers during formation of said security document. The weakly coherent region may be formed by application of heat and/or pressure.

The tamper evident means may include a colour altering substance arranged to change colour responsive to said one or more predetermined conditions.

Suitably, the tamper evident means is arranged to separate said portion of said document from the remainder of said security document and/or to change appearance upon exposure of said security document or token to one or more predetermined conditions including, but not limited to, the following: a specific range of temperature; a specific range of one or more forces; a specific range of impulses; and a specific range of pressures.

In one preferred embodiment, the composite security device comprises a composite image having a first part of the image provided by at least one security region of the first security layer and a second part of the composite image provided by at least one security region of the second security layer.

At least one and conveniently both of the security regions are formed by opacifying security coatings. The security coatings of the first and second security layers may have different opacity levels. Preferably the security regions may be formed from opacifying pigments which may differ in opacity and/or colour between the security layers. The opacifying coatings may be printed coatings. Suitably, the opacifying coatings may be applied using one or more of the following printing processes: gravure, silk screen, offset and flexo.

In alternative embodiments, the composite security device may comprise a security feature in one of the security layers which only indicates an authentic security state when viewed through a reading screen or decoding device in the security region of the other security layer. Examples of such composite security devices include: scrambled indicia in one security layer with a reading screen in the other layer; optically variable devices; a region printed with metameric inks in one security layer and as optical filter in the other layer, micro images and lenses; features which produce interference effects, such as Moire patterns; and polarising layers or patterns.

The security document preferably includes at least one layer of printed information or indicia over one or both of the security layers. Preferably, the printing is substantially omitted in the security regions of the security layers so that the composite security image or device can be viewed through a clear or translucent area from at least one side of the security document.

Preferred embodiments of the invention will now be described, by way of example only, with reference to the accompanying drawings, in which:

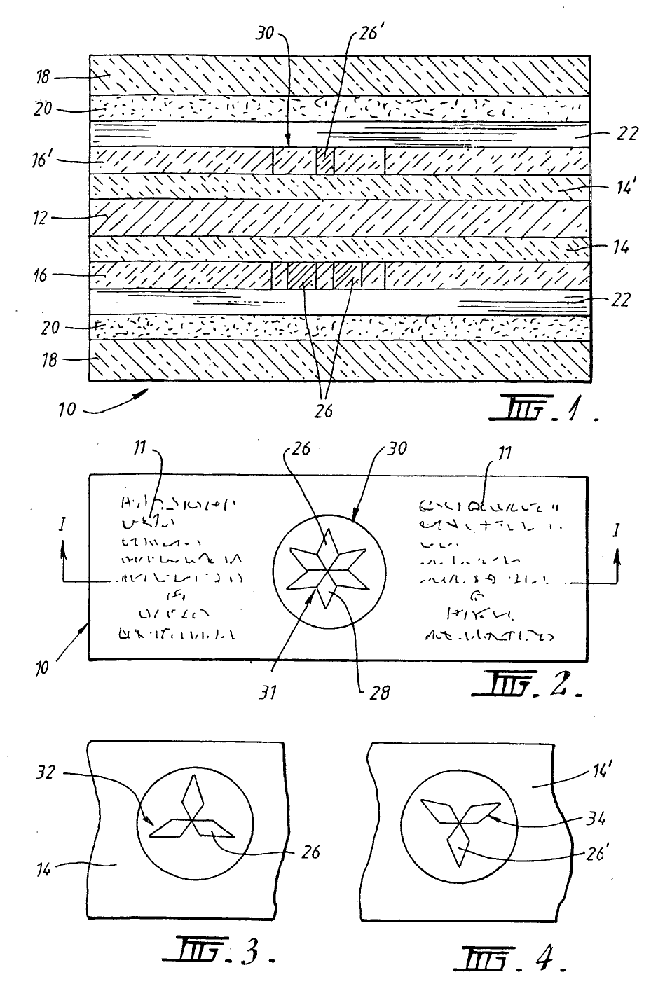

FIG. 1 is a schematic sectional view of a first embodiment of identity card in accordance with the invention taken on the line I-I of FIG. 2;

FIG. 2 is a schematic plan view of the identity card of FIG. 1 showing a composite security feature;

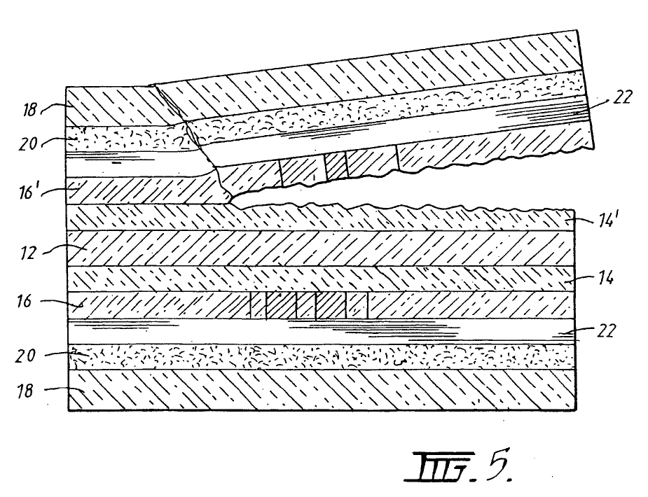

FIG. 3 is a plan view of part of a security layer of the card of FIG. 1;

FIG. 4 is a plan view of part of another security layer of the card of FIG. 1;

FIG. 5 is a sectional view showing an attempt to delaminate the identity card of FIGS. 1 and 2;

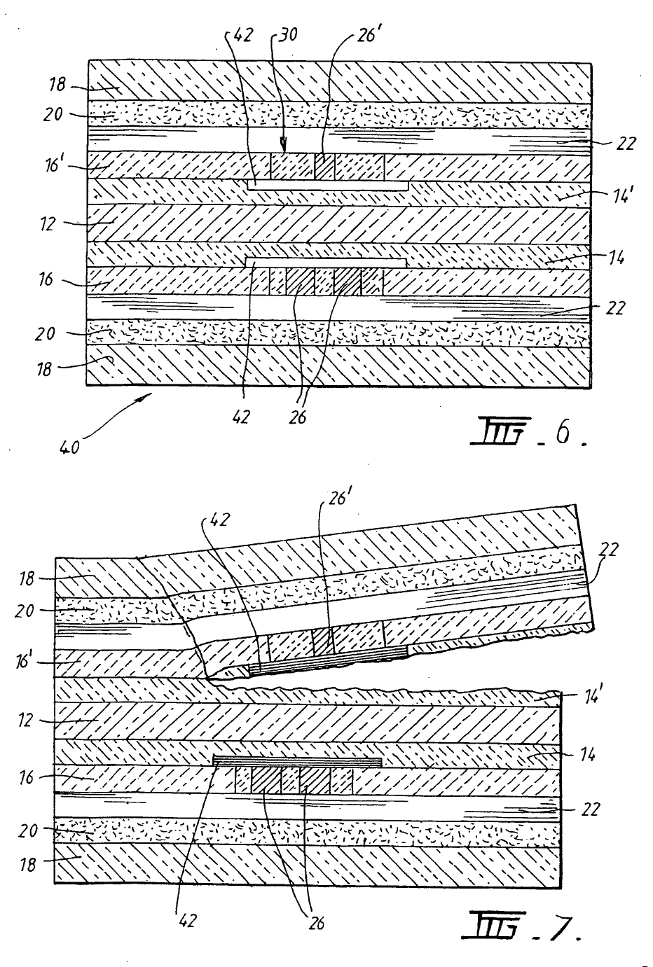

FIG. 6 is a schematic sectional view of another embodiment of a security document in accordance with the invention;

FIG. 7 is a sectional view showing an attempt to delaminate the security document of FIG. 6;

FIG. 8 is a schematic sectional view of a second embodiment of a security document in accordance with the invention;

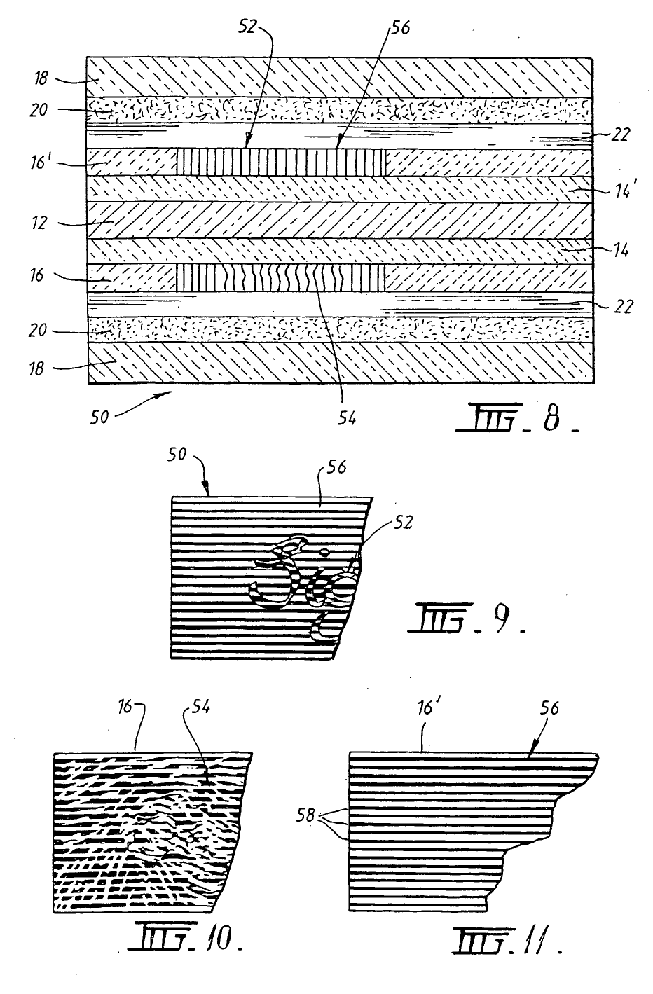

FIG. 9 is a partial plan view of a composite security feature of the security document of FIG. 8;

FIG. 10 is a partial plan view of one of the security layers forming the composite security feature of FIG. 9; and

FIG. 11 is a partial plan view of another security layer forming the composite security feature of FIG. 6.

FIGS. 1 and 2 show an identity card 10, which is one form of security document or token referred to previously in the present specification. It will be readily apparent to a person skilled in the relevant art that the features of the identity card 10 and processes by which it can be produced apply to other security documents or tokens. It will also be readily apparent to a person skilled in the relevant art that specific forms of the identity card 10 include indicia 11 on either or both sides of the identity card 10.

The identity card 10 is formed of a number of layers, which are laminated to a transparent or translucent support layer 12. The layers attached to one side of the support layer 12 can be identical to those attached to the other side of the support layer 12, in which case the identify card 10 is symmetrical about the support layer 12. However, different types of layers can be attached to each side of the support layer to form structurally different identity cards.

The support layer 12 is preferably formed from a transparent or translucent substrate of a stable and robust polymeric material, such as polyethylene terepthlate (PET). A first weakly coherent or adherent tamper-evident layer 14, such as polyethylene (PE) is provided on the support layer 12, e.g. by extrusion. A first security layer 16 is applied to an outer surface of the tamper-evident layer 14 and an outer laminate or layer 18 of a stable and robust material, e.g. PET or polyvinyl chloride (PVC) is applied over the security layer 16. The process is repeated on the other side of the support layer 12 to form an identity card that is symmetrical about the support layer 12, having a second tamper-evident layer 14′, a second security layer 16′ and another outer laminate layer 18 provided on the opposite side of the support layer 12.

The security layer 16 and corresponding security layer 16′ positioned on the other side of the support layer 12 are arranged to form a composite security device 30.

FIGS. 1 to 4, show one form of a composite security device 30 which may be formed by the security layers 16, 16′. The security device 30 comprises a composite image represented by a six pointed star 31 in FIG. 2. A first part 32 of the composite image 30, i.e. three points of the star, is formed by applying a security coating 26 of an opacifying pigment onto selected regions of the tamper evident layer 14 on one side of the transparent or translucent base layer 12 as shown in FIG. 3. A second part 34 of the composite image 30 is formed by applying a security coating 26′ of an opacifying pigment onto selected regions of the tamper evident layer 14′ on the opposite side of the transparent or translucent support layer 12. The security coatings 26, 26′ may be formed of different forms of pigment coatings such as described in WO83/00659, the different forms containing different proportions of a major portion of pigment in a minor portion of polymeric binder. The security coatings 26, 26′ may have different opacity levels and/or different colours to form the composite design and may be applied in a manner described in WO83/00659 which involves one or more of the following printing processes typically used in bank note printing: gravure; silk screen; offset; and flexo.

In an alternative form of the identity card 10, the security coatings 16, 16′ may be formed from the same pigment coating. In this form of the identity card 10 different levels of opacity of the security coatings can be provided by varying the number of layers of regions of the security coatings.

The support layer 12 of PET has a high glass transition temperature, the tamper-evident PE layers 14,4′ have a low glass transition temperature, the security layers 16, 16′ have a high glass transition temperature and the outer laminate layers 18 also have a high glass transition temperature. Preferably, the difference between the high and low glass transition temperatures is at least 30° C., and more preferably at least about 50° C. As will be readily apparent to persons skilled in the relevant field, layers 12, 14 and 14′ and 18 can be formed of different materials to those listed above that have similar properties. For example, the transparent or translucent support layer 12 may be formed of polycarbonate or polypropylene and the outer laminate layer 18 may be formed of these materials or polyvinyl chloride (PVC).

The outer laminate layers 18 may be attached to the security layers 16, 16′ using heat and pressure. Optional adhesive layers 20 may be used to enhance the bond between the security layer 16, 16′ and the outer laminate layers 18.

The identify card 10 can be personalised in a number of different ways. For example, prior to attachment of the outer laminate layers 18, printing 22 may be applied over one or both of the security layers 16, 16′ using, for example, offset printing, silk screen printing and/or ink jet printing. Alternatively or additionally, information can be attached to an outside surface of the outer laminate layer by dye-diffusion thermal transfer printing. Information can also be imprinted on outer and inner surfaces of the outer laminate layers 18 by intrusive techniques such as laser engraving.

The authenticity of the identity card 10 can be determined by simultaneously viewing the composite security device 30 formed by the security coating 26 and the corresponding security coating 26′ positioned on the opposite side of the support layer 12. The security coatings 26, 26′ are designed to be viewed by looking through at least partially clear laminated layers of the identity card 10 in a direction which is approximately perpendicular to planes in which the laminated layers lie, and are therefore preferably positioned in a substantially clear region of the identity card 10 to which little or no printing 22 or other indicia 11 is applied over the security device.

Fraudulent alteration of identity cards or other security documents or tokens can involve delamination of the security document. Delamination typically involves the application of heat until the temperature of the card is such that layers forming the card begin to delaminate. Once the security document has been delaminated variable data which is stored in the security document is accessible. Following alteration of the variable data, the security document is reassembled to conceal fraudulent alteration.

As shown in FIG. 5, attempts to delaminate the identity card 10 of the present invention using the application of heat either deform or destroy the low glass transition temperature PE layer 14′ resulting in separation of the security layer 16′ from the support layer 12 and from the security coating 16 on the other side of the support layer 12. Unless the security layer 16′ is repositioned relative to the support layer and corresponding security layer 16 so that the parts 26 and 26′ of the composite security device 30 are perfectly in register, using methods similar to those involved in assembly of the authentic identity card 10, it is virtually impossible to reassemble the identify card 10 in an authentic manner.

One preferred form of the identity card 10 is designed so that an authentic card requires the weakly coherent or adherent tamper evident layers 14, 14′. In this form of the identity card 10, deformation, destruction or removal of the at least one of the tamper-evident layers 14, 14′ affects visual interaction of the security coatings 16, 16′ which are positioned on opposite sides of the support layer 12 to form the composite security device 30. Authentic visual interaction thus requires the presence of the tamper-evident layers 14, 14′.

Another form of the identity card 40 shown in FIGS. 6 and 7 includes a tamper evident material 42 located in the tamper-evident layers 14 and 14′. The tamper evident material may provide an additional security feature. The tamper evident material may be formed of a heat and/or oxygen sensitive material which either changes from being clear or translucent to an opaque colour, or which changes colour upon the application of heat or exposure of the tamper-evident layer 14, 14′ to the atmosphere upon separation from the support layer 12. The change of colour of one or both of the tamper-evident layers 14, 14′ as shown in FIG. 7 indicates that the identity card 40 has been tampered with and that it is not authentic.

Another embodiment of a tamper evident security document 50 in accordance with the invention is shown in FIGS. 8 to 11. The security document 50 is formed from several layers in similar manner to the identity card 10 of FIGS. 1 to 4 and corresponding reference numerals have been applied to corresponding parts. The security document 50 differs from that of FIGS. 1 to 4 in that it includes a composite security device 52 in the form of scrambled indicia 54 provided in the security layer 16 on one side of the transparent support layer 12 (FIG. 10) and a lenticular reading screen 56 in the form of a series of parallel lines 58 in the security layer 16′ on the opposite side of the support layer 12 (FIG. 11). The composite security device 52 seen when the scrambled indicia 54 as shown in FIG. 9 is part of an unscrambled signature. It will, however, be appreciated that a wide variety of security images may be formed by scrambled indicia in the form of broken or interrupted lines in combination with an appropriate reading screen.

It will be appreciated that various other types of composite security devices may be formed by the security layers 16, 16′ within the scope of the present invention. For example, one of the security layers 16′ may incorporate a decoding device such as an optical screen or lens, e.g. an optical or colour filter, a lenticular screen or an array of microlenses, and the other security layer 16 may include an optically variable image, e.g. printed from metameric inks, or a micro image which is only verifiable when in registration with the decoding device. Another possibility is for the security layers 16, 16′ to incorporate sets of fine lines or dots which together produce an interference effect, such as a Moire pattern when in register. In a further embodiment, at least one of the security layers 16, 16′ may incorporate a polarising layer for viewing another polarising layer or pattern in the other security layer.

It will be understood that the invention disclosed and defined in this specification extends to all alternative combinations of two or more of the individual features mentioned or evident from the text an/or drawings. All of these different combinations constitute various alternate aspects of the invention. Various changes and modifications may be made to the embodiments described and illustrated without departing from the present invention.

It will also be understood that the term “comprises” (or its grammatical variance) as used in this specification is equivalent to the term “includes” and should not be taken as excluding the presence of other elements or features.

1. A laminated security document comprising:
a transparent or translucent support layer;
a first security layer provided on one side of the support layer;
a second security layer provided on the opposite side of the support layer;
the first and second security layers having security regions which together form a composite security image or device to indicate an authentic security state:
a first tamper evident means provided between the support layer and the first security layer;
a second tamper evident means provided between the support layer and the second security layer;
wherein upon exposure of the security document to predetermined conditions to delaminate the document, at least one of the tamper evident means is arranged to destruct or otherwise affect at least one of the security layers to indicate an unauthentic security state.

2. A security document according to claim 1 wherein at least one of the tamper evident means is arranged to separate a portion of the security document containing one of the security layers from the remainder of the security document upon exposure to the predetermined conditions.

3. A security document according to claim 2 wherein the tamper evident means comprises a region which destructs or deforms upon exposure to the predetermined conditions to result in separation of said portion of the security document.

4. A security document according to claim 2 wherein at least one of the tamper evident means comprises a weakly coherent or adherent tamper evident layer.

5. A security document according to claim 4 wherein the tamper evident layer is formed from a material having a glass transition temperature which is lower than the glass transition temperature of the material from which the support layer is formed.

6. A security document according to claim 4 further comprising at least one outer layer over at least one of the security layers.

7. A security document according to claim 6 wherein said outer layer is formed from a polymeric material having a glass transition temperature which is higher than the glass transition temperature of the material from which the tamper evident layer is formed.

8. A security document according to claim 5 wherein the difference between the low glass transition temperature of the tamper evident layer and the high glass transition temperature of the support layer and/or the outer layer is at least 30° C.

9-12. (canceled)

13. A security document according to claim 4 wherein the tamper evident layer is formed from polyethylene.

14. (canceled)

15. A security document according to claim 6 wherein the support layer and/or the at least one outer layer is formed from any one or more of the following: polyethylene terepthalate (PET); polycarbonate; polypropylene; or polyvinyl chloride (PVC).

16. (canceled)

17. A security document according to claim 1 wherein at least one of the tamper evident means includes a material that changes appearance upon exposure to predetermined conditions.

18. A security document according to claim 17 wherein said material of the tamper evident means changes from a transparent or translucent state to a coloured or opaque state upon exposure to the predetermined conditions.

19. A security document according to claim 17 wherein said material of the tamper evident means changes from one colour to another colour upon exposure to the predetermined conditions.

20. (canceled)

21. A security document according to claim 1 wherein the composite security device comprises a composite image having a first part of the image provided by at least one security region of the first security layer and a second part of the composite image provided by at least one security region of the second security layer.

22. A security document according to claim 1 wherein at least one of the security regions is formed by an opacifying security coating.

23-27. (canceled)

28. A security document according to claim 1 wherein the composite security device comprises a security feature in one of the security layers which only indicates an authentic security state when viewed through a reading screen or decoding device in the security region of the other security layer.

29-40. (canceled)

41. A method of manufacturing a laminated security document comprising:
applying a first tamper evident means on one side of a transparent or translucent support layer;
applying a second tamper evident means on the opposite side of the transparent or translucent support layer;
applying a first security layer over the first tamper evident means;
applying a second security layer over the second tamper evident means;
the first and second security layers having security regions which together form a composite security device or image to indicate an authentic security state; and
wherein, upon exposure of the security document to predetermined conditions to delaminate the document, at least one of the tamper evident means is arranged to destruct or otherwise affect at least one of the security layers to indicate an unauthentic security state.

42. A method according to claim 41 wherein at least one polymeric outer layer is applied over at least one of the security layers.

43. A method according to claim 41 wherein at least one of the tamper-evident means is a weakly coherent or adherent tamper evident layer.

44-46. (canceled)

47. A method according to claim 41 wherein at least one of the tamper evident means includes a substance that changes appearance or colour upon exposure to the predetermined conditions.

48. A method according to claim 41 wherein at least one of the security regions of the security layers is an opacifying coating applied over the tamper evident means.

49. A method according to claim 48 wherein opacifying security coatings are applied over each of the first and second tamper evident means to form a composite security device.

50. A method according to claim 49 wherein opacifying coatings having different opacity levels are applied over the first and second tamper evident means.

51-53. (canceled)
